(19) United States
(12) Patent Application Publication
(10) Pub. No.: US 2017/0004827 A1
(43) Pub. Date: Jan. 5, 2017

(54) Data Collection and Reporting System and Method

(71) Applicant: Siemens Energy, Inc., Orlando, FL (US)

(72) Inventors: Alejandro Bancalari, Casselberry, FL (US); Clifford Hatcher, JR., Orlando, FL (US); Forrest R. Ruhge, Orlando, FL (US); Joshua DeAscanis, Altamonte Springs, FL (US)

(21) Appl. No.: 14/755,915

(22) Filed: Jun. 30, 2015

(51) Int. Cl. G10L 15/22; G06F 3/16; G10L 25/48; G06F 1/16

(52) U.S. Cl. CPC G10L 15/22; G06F 1/163; G06F 3/16; G10L 25/48; G10L 2015/223

(57) ABSTRACT

A wearable device is provided that is configured to carry out an inspection of a gas turbine or other type of system. The device may include a processor, a data store, at least one output device, and at least one input device. The processor in the wearable device is responsive to inputs through the at least one input device and set of tasks stored in the data store corresponding to an inspection of a system to provide outputs through the at least one output device that prompt a user to gather data associated with the system being inspected using the wearable device while the wearable device is mounted to the user without the user holding the wearable device with the hand of the user. Also, the processor in the wearable device is configured to generate and output an inspection report responsive to the set of tasks and the data gathered using the wearable device.

### TECHNICAL FIELD

The present disclosure is directed, in general to energy generation systems including gas turbines or any other systems that generate energy.

### BACKGROUND

Energy generation systems such as gas turbines often require service and inspection operations to be carried out. Such service and inspection operations may benefit from improvements.

### SUMMARY

Variously disclosed embodiments include systems and methods that may be used to collect and report data for an inspection of a gas turbine or any other type of system including equipment and/or buildings. An example embodiment of a system usable to carry out such an inspection may comprise a wearable device including a processor, a data store, at least one output device, and at least one input device. The processor in the wearable device may be responsive to inputs through the at least one input device and a set of tasks stored in the data store corresponding to an inspection of a system to provide outputs through the at least one output device that prompt a user to gather data associated with the system being inspected using the wearable device. In this example, the wearable device may have a configuration that enables the user to carry out the inspection while being mounted to the user without the user holding the wearable device with the hand of the user. In addition, the processor in the wearable device may be configured to generate and output an inspection report responsive to the set of tasks and the data gathered using the wearable device.

In another example, a method may include various acts carried through operation of a processor included with a wearable device including a data store, at least one output device, and at least one input device. Such acts may include responsive to inputs through the at least one input device and a set of tasks stored in the data store corresponding to an inspection of a system, providing outputs through the at least one output device that prompt a user to gather data associated with the system being inspected using the wearable device while the wearable device is mounted to the user without the user holding the wearable device with the hand of the user. Such acts may also include generating and outputting an inspection report responsive to the set of tasks and the data gathered using the wearable device.

A further example may include non-transitory computer readable medium encoded with executable instructions (such as a software component on a storage device) that when executed, causes at least one processor to carry out this describe method.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the Detailed Description below, it may be advantageous to set forth definitions of certain words or phrases that may be used throughout this patent document. For example, the terms “include” and “comprise,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to describe various elements, functions, or acts, these elements, functions, or acts should not be limited by these terms. Rather these numeral adjectives are used to distinguish different elements, functions or acts from each other. For example, a first element, function, or act could be termed a second element, function, or act, and, similarly, a second element, function, or act could be termed a first element, function, or act, without departing from the scope of the present disclosure.

In addition, phrases such as “processor is configured to” carry out one or more functions or processes, may mean the processor is operatively configured to or operably configured to carry out the functions or processes via software, firmware, and/or wired circuits. For example a processor that is configured to carry out a function/process may correspond to a processor that is actively executing the software/firmware which is programmed to cause the processor to carry out the function/process and/or may correspond to a processor that has the software/firmware in a memory or storage device that is available to be executed by the processor to carry out the function/process. It should also be noted that a processor that is “configured to” carry out one or more functions or processes, may correspond to a processor circuit particularly fabricated or “wired” to carry out the functions or processes (e.g., an ASIC or FPGA design).

The term “adjacent to” may mean: that an element is relatively near to but not in contact with a further element; or that the element is in contact with the further portion, unless the context clearly indicates otherwise.

Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 illustrates a functional block diagram of an example system that facilitates data collection and reporting during an inspection of a system using a wearable device.

FIG. 2 illustrates an example flow of task requests and corresponding task inputs for a set of tasks associated with an inspection of a system carried out with a wearable device.

FIG. 3 illustrates an example of an inspection report that may be generated by a wearable device.

FIG. 4 illustrates a flow diagram of an example methodology that facilitates data collection and reporting during an inspection of a system using a wearable device.

FIG. 5 illustrates a block diagram of a data processing system in which an embodiment can be implemented.

### DETAILED DESCRIPTION

Various technologies that pertain to data collection and reporting for energy generation systems and other types of systems will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged systems. It is to be understood that functionality that is described as being carried out by certain system components may be performed by multiple components. Similarly, for instance, a component may be configured to perform functionality that is described as being carried out by multiple components. The numerous innovative teachings of the present application will be described with reference to exemplary non-limiting embodiments.

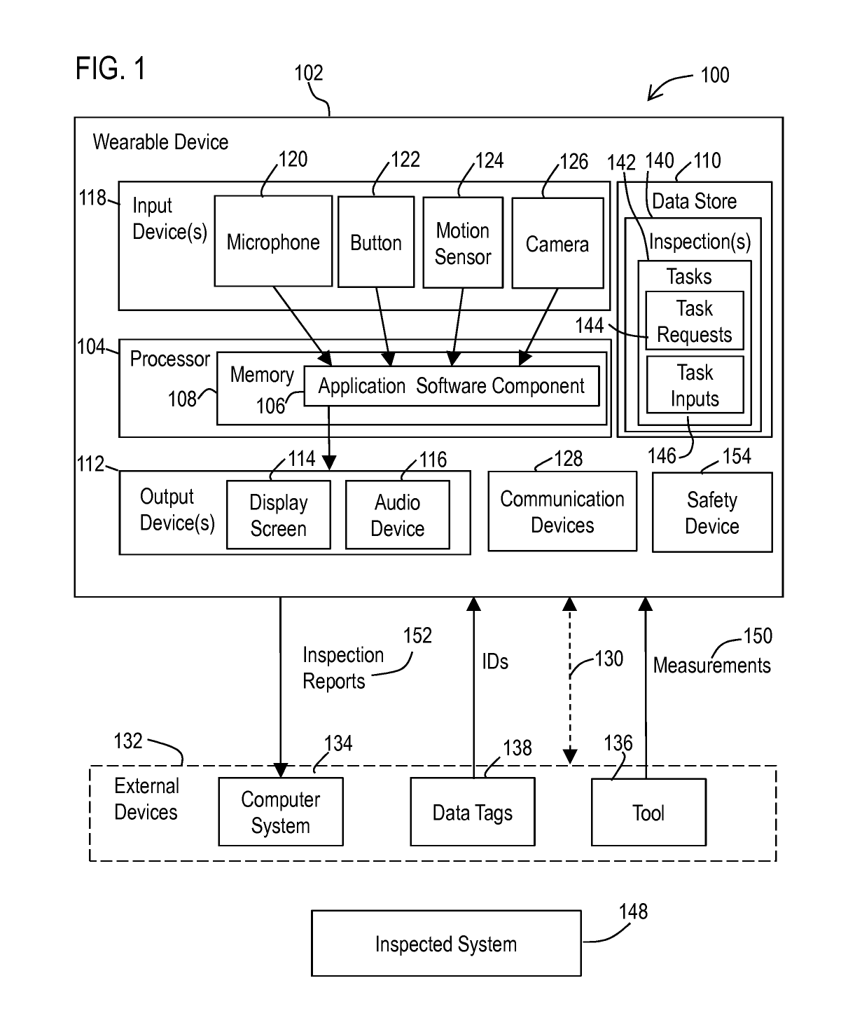

With reference to FIG. 1, an example system 100 that facilitates data collection is illustrated. The system 100 may include a wearable device 102. Wearable devices include computer systems that are provided in form factors sufficiently small and light to attach to a person's body and/or clothing in a manner that does not impede the person's ability to carry out activities with their hands and do not cause muscle fatigue when worn for many hours at a time.

Example form factors for wearable devices may include eyewear that is supported by a person's nose and ears in a similar manner in which glasses are mounted to a person. Eyewear type wearable devices may or may not include lenses. A publicly available eyewear device for some example embodiments may include Google Glass smart glasses provided by Google, Mountain View, Calif. Another example of a form factor for a wearable device described herein may correspond to devices that mount around the wrist of a person with a band similar to the manner in which a wrist watch is mounted to a person. A wrist worn wearable device for some example embodiments may include a Samsung Gear 2 smartwatch provided by Samsung Electronics, Suwon, South Korea or other type of smartwatch.

In example embodiments, the wearable device may include a processor 104 that is configured to execute one or more application software components 106 from a memory 108 in order to carry out the various features described herein such as data collection and reporting. The application software component 106 that provides data collection and reporting be may be an independent application comprised of one or more components and/or may be integrated/included with software that carries out other functions.

In an example embodiment, the memory 108 may correspond to a data store in which data used by and acquired by the application software component 106 is stored. However, it should be appreciated that the wearable device may include other data stores 110 such as an internal flash memory and/or a card reader that is operable to read and store data on a removable flash memory such as a microSD card.

In example embodiments, the wearable device may also include one or more output devices 112 such as a display screen 114 and an audio device 116 (i.e., a speaker or other sound emitting device). Also, the wearable device may also include one or more input devices 118 such as a microphone 120, button(s) 122, and motion sensors 124 (i.e., accelerometers, gyroscopes) and a camera 126. In addition, the wearable device may also include one or more communication devices 128 that provide communications 130 such as wired communications (e.g., via a USB port) and/or wireless communications (e.g., via NFC, Bluetooth, WiFi-IEEE 802.11, MiFi-IEEE 802.15.4, and/or cellular) between the wearable device 102 and one or more external devices 132.

Such external devices for example may include local or remote computer systems 134 (e.g., a remote server, a local PC, a local or remote mobile phone) that receive data from and send data to the wearable device. Such external devices may also include measurement tools 136 such as a Bluetooth enabled caliper, thermometer, vibration sensor, or other tool that is operable to measure a physical property of a portion of a system and provide measurement data 150 to the wearable device. Such external devices may also include data tags 138, such as an RFID and/or NFC tag that provide serial numbers or other identifications (ID) data to the wearable device.

In an example embodiment the data collection and reporting carried out using the wearable device may correspond to an inspection of a system that requests several inspection tasks to be performed. Such a system for example may involve the inspection of power generation equipment such as a gas turbine, steam turbine, wind turbine, or any other equipment used in the generation of energy. Such a system may also correspond to a distributed system such as the components and structure that comprise a commercial or residential building, manufacturing plant, or any other type of facility. In other embodiments, the data collection and reporting may be carried out with respect to any other type of inspection that may require the user to carry out a plurality of tasks involved with collecting data which may require the user to move to different locations to collect the data while carrying various tools.

It should also be appreciated that the wearable device may include or be integrated into safety devices 154 typically worn during inspections. Examples of such safety devices that may comprise or be comprised by a wearable device may include safety glasses, goggles, noise reduction earmuffs, and hard hats.

In an example embodiment, the processor 104 in the wearable device 102 is responsive to inputs through the at least one input device 118 and a set of tasks 142 stored in the data store 110 corresponding to an inspection 140 of a system 148, to provide outputs through the at least one output device 112 that prompt a user to gather data associated with the system being inspected using the wearable device. In this example, the wearable device has a form factor (such as a smart watch or smart glasses) that enables such data collection using the wearable device while the wearable device is mounted to the user without the user holding the wearable device with the hand of the user. In this described embodiment, the processor in the wearable device is configured to generate and output an inspection report 152 responsive to the set of tasks 142 and the data gathered using the wearable device for the inspection 140.

In an example embodiment, the processor 104 may be configured (via the application software component 106) to cause the at least one output device 112 to output verbal, visual, and/or textual descriptions of tasks requested to be performed for an inspection which are referred to herein as task requests 144. For example, the data store 110 may be configured to store one or more inspections in the form of an XML file, JSON data, SQL records, audio files, images, or any other form of data format/storage that is capable of providing a description of tasks that are requested to be performed for an inspection.

Such tasks may correspond to providing data for the inspection that are known to the user or gathered from the system. Such tasks may also include carrying out actions with the system and indicating the outcome of the action. In addition, tasks may include determining the condition of a portion of a system and providing information about the condition. Further, Action may include acquiring measurements of the system using tools operated by the user.

In an example embodiment, the data that represents an inspection may be comprised of a set of tasks 142 which include or reference data (text, audio files, image files) usable to form respective task requests 144 that are outputted through one or more output devices of the wearable device. Such task requests may correspond to audible and/or visible instructions that prompt the user to carry out the respective task and/or explain how to carry out the task. In example embodiments, the tasks for an inspection may be organized in a particular order that is specified in the inspection data stored in the data store. The processor may be configured to output the task requests for the tasks in the specified order (e.g., a first task and task request, followed by a second task and task request, followed by a third task and task request, etc.).

The task request data 144 may include verbal audio information outputted through the audio device 116 and/or textual/graphical information outputted through a display screen 114, which prompt a user to provide task inputs 146 for each task. The task request may also provide verbal, textual, and/or visual information helpful in carrying out the task, such as a picture of a part, directions to a particular location, and/or any other information useful to carry out a task.

In example embodiments, a user may respond to each task request 144 with a task input 146 that provides information requested in the task request. The processor may receive data corresponding to task inputs 146 through operation of one or more of the internal input devices 118 and may stored such task input data in the data store 110. In example embodiments, task inputs may correspond to verbal inputs through a microphone, image inputs through the camera, motion inputs through the motion sensors, and/or button inputs through a button, key, or touch pad, or touch screen of the wearable device. In addition, the processor may receive data corresponding to task inputs 146 from one or more of the external devices 132, such as tools 136 that wirelessly communicate measurements 150 of the system 148 (requested to be made by the task request) to the wearable device.

In example embodiments, the processor of the wearable device may be configured to store task inputs in the data store 110 in correlated relation with the respective task 142 having the task request that prompted the use to acquire the respective task input. Thus, a first task input provided in response to a first task request may be stored in the data store in correlated relation with the first task. Also for example, a second or subsequent task input provided in response to a second or subsequent task request may be stored in the data store 110 in correlated relation with the second or subsequent task.

The processor may be configured to determine which tasks have and have not been completed (e.g., have task input data associated therewith). For example, the processor may store data in the data store 110 that specifies which tasks are completed. The indication that a task is complete may be provided in the data store by associating a complete status with the task. Thus the processor may be operative to determine that a task is complete by retrieving the complete status information. In addition or alternatively, the processor may be operative to determine that a task is complete by the presence of data corresponding to the task input being stored in the data store in correlated relation with the task.

When a task input has been received, the processor may be configured to automatically update the database to reflect that the task request has been completed (via a complete status update and/or by associating the task input with the task request). In addition, when a task request has been completed, the processor may automatically begin outputting through the output device, the next subsequent task in the specified order for the set of tasks requests stored in the data store. However, in alternative embodiments, the processor may be configured to be responsive to an input (such as a verbal “NEXT TASK” input) received through one of the input devices that is representative of a command to proceed to the next task, in order to begin outputting the next task in the set of tasks for an inspection.

In addition, the processor may be responsive to other navigation or help commands that assist the user in carrying out the acquisition of task inputs for a set of task. For example, if the user did not hear or understand a task request correctly, the processor may be configured to detect an input (such as the verbal phrase “REPEAT TASK”) and in response thereto, cause the current task request to be repeated through one or more output devices.

Also for example, if the user would like to repeat a prior task, the processor may be configured to detect an input (such as the verbal phrase “PRIOR TASK”) and in response thereto, cause the prior task (associated with the task prior to the current task) to become the current task and to repeat the associated prior task request through one or more output devices.

If a task request cannot be completed, the processor may be configured to detect an input (such as the verbal phrase “SKIP TASK”) and in response thereto, cause the current task to be skipped and to begin outputting the next subsequent task request, without providing data that specifies that the prior task request is complete.

It should be noted that such navigation commands may be provided by verbal commands communicated through the microphone of the wearable device. In addition or alternatively, such commands may be provided through inputs through one or more buttons, keys, touch pads, touch screens, dials, motions sensors, or any other input device associated with the wearable device.

When the last task of a set of tasks has been completed (or skipped), the processor may be configured to determine if any task requests have been skipped. If any tasks have been skipped, the processor may be configured to output a verbal and/or textual query that requests that the user provide a confirming command to cause the processor to repeat all of the skipped task requests. If the processor detects the confirming command, the processor may proceed to repeat each skipped task request starting from the first skipped task and proceeding in the order specified in the data store for the set of tasks that were not completed.

In addition, if the processor determines that all tasks requests are complete, and/or the user does not provide a command to repeat skipped task requests, the processor may be configured to carry out an action on the set of tasks, such as generating the inspection report 152 based on the tasks 142 and associated task inputs 146 for an inspection 140, and/or forwarding such a report and/or data corresponding to the task requests and associated task inputs to another computer system 134 (e.g., server, mobile phone, PC, cloud storage).

For example, the processor may be configured to generate a report that includes a description of each task and its corresponding task input (or an indication that the task was skipped). Such a report may be generated from the task data stored in the data store. For example the report may include a textual description of each task of an inspection. Such a textual description may correspond to a summary of the task and/or may correspond to the text of the task request itself.

The processor may be operative to convert audio task inputs into corresponding text using a speech detection module of the wearable device. Thus the report may include the task inputs in the form of text converted from audio inputs. In addition, the report may include pictures captured with the camera for task inputs. In addition, the report may include measurement data for task inputs captured with an external tool.

In an example embodiment, the processor may be configured to generate the Report in a common document format such as an Acrobat PDF file, a DOCx file, an XML file (with associated image files, audio files, or other data files referenced in the XML file), or any other type of document that can display tasks and corresponding task inputs.

It should be appreciated that inspections of industrial equipment may be conducted in a nosy environment where it is difficult to hear verbal information through headphones or speakers of a wearable device. Thus, in addition to outputting verbal information through an audio output device, the processor may cause corresponding textual information to be outputted on a display device of the wearable device. Also it should be appreciated that the application software component that causes the task requests to be outputted may be configured by a user to output either verbal task requests, textual task requests, or both. Also, it should be appreciated that information outputted through a display device may include (in addition to a textual description of the task request) images or graphics that assist the user in locating and/or inspecting a particular object being inspected for a task.

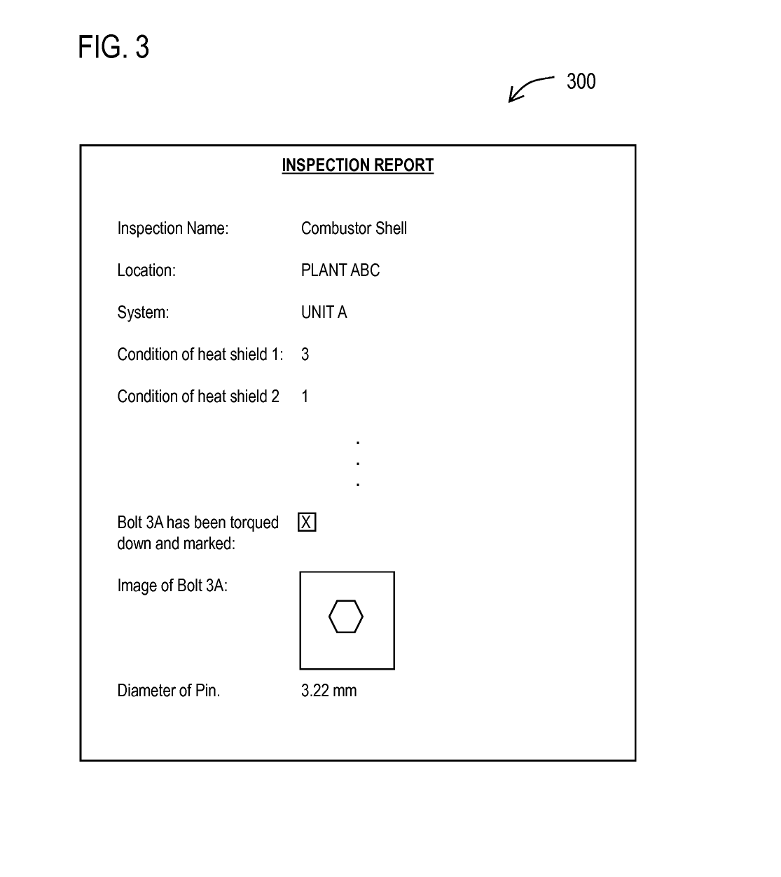

FIG. 3 illustrates an example flow 300 of task requests and task inputs of a wearable device that enable a user to carry out a set of tasks for a portion of an inspection of a system. In this example, the flow 300 may begin with an input that triggers the device to begin accepting verbal commands. For example, a wearable device may continuously be in a mode that listens via a microphone for a verbal trigger phrase 202 such as “OK Device” or other triggering phrase. When such a verbal triggering phrase is detected, the wearable device may start listening for commands that control the operation of the wearable device.

Such a command that is detected via a verbal input through the microphone may include a command 204 such as “Start” followed by the name 206 of the application software component (e.g., “Field Inspection Procedure”) that is to be executed by the processor to carry out the data collection and reporting described herein. In this example, the phrase may also include key word such as “for”, which introduces the name 208 of the particular inspection (e.g., “Combustor Shell”) that is carried out by the application software component. Such an inspection name may correspond to a name of an inspection file or data field in a database where the inspection (and associated tasks) is stored.

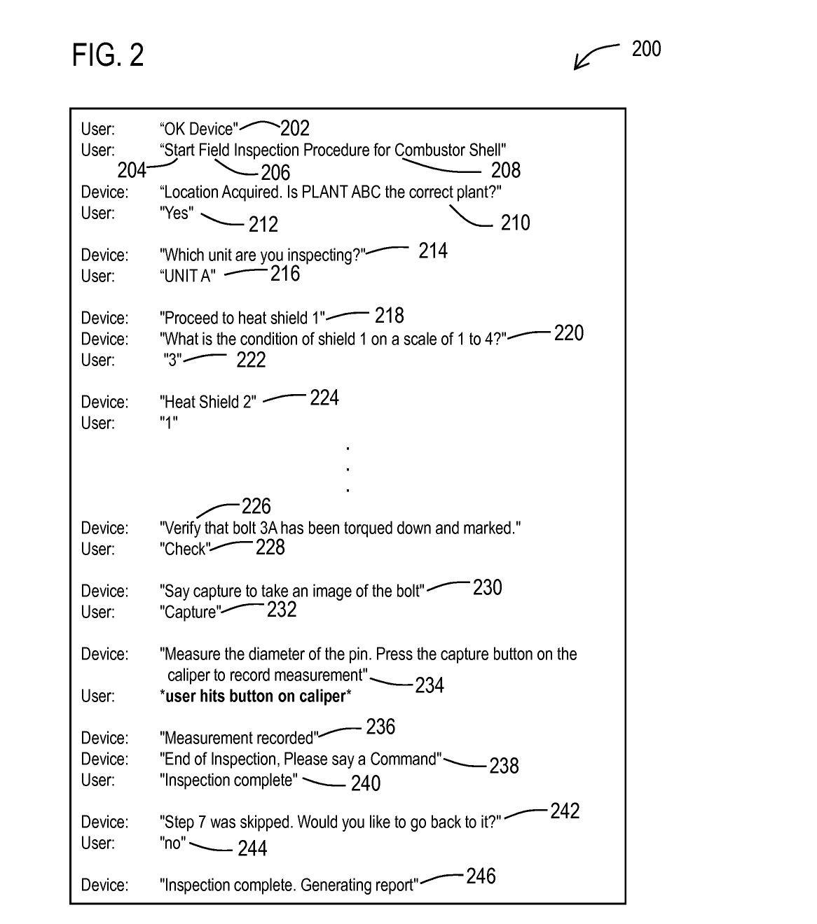

In an example embodiment, the wearable device may include a GPS or other location determining device/software that is capable of determining the current location of the wearable device. Also, the data store may include a list of locations (such as plants, or buildings) that an inspection will typically take place. The application software component may thus correlate the current location with the list of locations and generate an output through the output device that lists the correlated location and requests the user to confirm the inspection location is being carried out at this correlated location. For example as illustrated in FIG. 2, the application software component may determine that the wearable device is at the location PLANT ABC, and may then output the phrase 210 “Location acquired. Is PLANT ABC the correct plant?”.

After this phrase is outputted, the application software component may enter a mode where it is operative to listen for a “YES” or “NO” response, which in this example may be detected verbally through an input from the microphone. If the user answers with the word “NO”, the application software component may be operable to ask the user for the location of the inspection.

Also if the user answers with the response 212 “YES” , the application software component may request further information about what is being inspected. For example in this example, the application software component may output the query 214 “Which unit are you inspecting” . To reply, the user may provide a verbal answer 216 through the microphone such as “UNIT A.”

Also in other examples, rather than verbally providing an identification or name for a particular system being inspected, the user may scan a barcode associated with the system with the camera of the wearable device and/or may detect an RFID signal from an RFID tag associated with the system. Also, in further examples, the application software may be operative to output a list of possible systems to inspect, and the user may choose via an input which of the listed systems for which the current inspection is being conducted.

It should be appreciated that both of the queries: “Is Plant ABC the correct plant?” 210 and “Which unit are you inspecting?” 214 correspond to task requests for tasks of the selected inspection “Combustor Shell”. Also, the answers “Yes” 212 and “UNIT A” 216 correspond to inputs from which task inputs are determined. For example, in response to these inputs the application software component may store corresponding task input data such as “PLANT ABC” and “UNIT A” in the data store for tasks associated with determining the plant location and unit name for the selected inspection.

It should be appreciated that once a task input has been stored for a task, the application software component may automatically proceed to the next task. However, as indicated previously, in alternative embodiments, the user may provide a command such as “Next Task” to cause the application software component to move to the next task and output another task request.

As shown in FIG. 2, the set of tasks may include one or more task requests 218, 220, 224 that prompt a user to move to a particular location and provide information about a condition of one or more portions of the selected system. For example, the wearable device may prompt the user with a command 218 to “Proceed to heat shield 1”, which may be followed by a query 220 such as “What is the condition of a shield 1 on a scale of 1 to 4”. The user may provide a verbal input which is translated into a numerical number 222 (such as “3”) for a task input that is stored in the data store in association with the current task.

To assist a user in accurately determining a condition, the application software component may be configured to cause the display device of the wearable device to provide images of example conditions. For example, for a scale of 1 to 4, the application software component may output one or more example images of the part for each of the four different condition levels. The user may compare such images to the visual appearance of the actual part to determine which condition level best corresponds to the current condition of the part.

In further embodiments, the application software component may be operative to provide verbal directions, an image of a map, direction arrows to the next part to evaluate, or outputs of other information that assist a user in moving to the correct portion of the system that is the subject of the next task.

Other tasks and corresponding task requests may prompt the user to provide a verification of some characteristic of the system such as a verification 226 to “Verify that bolt 3A has been torque down and marked”. In response the user may provide an input such as “Check” to confirm that the characteristic has been verified. Such a “Check” input 228 may correspond to a task input stored in the database that the particular characteristic is present for the portion of the system requested to be verified.

As discussed previous, one of the input devices of a wearable device may include a camera. Thus, task inputs may correspond to an image captured with the camera. For example as illustrated in FIG. 2, a task may include a task request 230 to capture an image of a particular part of the system such as “Say capture to take an image of the bolt”. In response to this task request, the user may align the camera of the wearable device so as to be in a position to take an image of the requested part. The user may also provide the indicated verbal command 232 “Capture” which causes the wearable device to operate the camera to capture an image of the requested part. Such an image may correspond to a task input that is stored in correlated relation with the current task in the data store.

Also, as discussed previously, the wearable device may be configured to receive task inputs from an external device such as a tool. For example as shown in FIG. 2, the application software component may be operative to provide a task request 234 associated with taking a measurement with a tool wirelessly connected to the wearable device such as “Measure the diameter of the pin. Press the capture button on the caliper to record measurement”. In response to this prompt, the user may measure the pin with his caliper and hit the appropriate capture button on the tool to cause the tool to transmit the measurement to the wearable device.

Such a measurement received by the wearable device corresponds to a task input that is stored in the data store in correlated relation with the task that prompted the measurement to be taken. As wireless devices may occasionally have communication problems with an external tool, an example embodiment, may provide a further confirming output 236 such as “Measurement Recorded”.

Once the last task of the set of tasks has received a task input or has been skipped, the application software component may be configured to indicate that the end of the inspection has been reached and to prompt the user for further instructions with a prompt 238 such as: “End of Inspection, Please say a Command”

The user may then provide a command to carry out another inspection with a verbal command similar to the initial command instructions 204, 206, 208 that stared the described inspection to be carried out. In addition, the application software component may be configured to detect a command to end the inspection with a phrase 240 such as “Inspection complete”.

In response to the user providing such a command or alternately responsive to the end of the inspection being determined, the application software component may be configured to determine if any tasks have been skipped and to query the user whether they would like to go back to a skipped task such as with the prompt 242 of “Step 7 was skipped. Would you like to go back to it?”.

If the user provides an input 244 of “No” the application software component may then proceed to a mode in which it generates an inspection report for the tasks and task inputs of the inspection. The application software component may also provide an output 246 that indicates to the user that the report is being generated such as “Inspection complete. Generating report”.

The wearable device may store the generated report in the data store. Also, the wearable device may be operative to output the generated inspection report to an external computer system via a wireless upload, e-mail, or other communication. An example of an inspection report 300 generated from the task inputs shown in FIG. 2 is illustrated in FIG. 3. However, it should be appreciated that example embodiments may include many different formats for displaying information on an inspection report depending on the type of tasks be carried out, the types of tasks inputs received and the overall appearance of the report that is desired.

It should also be appreciated that the application software may enable the user to provide supplemental data on the condition of a system. For example, before the inspection is completed, the user may provide a command for the application software component to change to a mode in which the user is able to provide verbal comments, additional camera images, additional measurements or any other data that the wearable device is capable of capturing. In this mode the user for example may provide comments on the system such as “System is dripping oil” and may cause the wearable device to capture an image of the dripping oil for inclusion with the inspection report.

It should also be appreciated that the inspection stored in the data store may in some embodiments correspond to a linear list of tasks to carry out for an inspection. However in other embodiments, the inspection may correspond to a dynamic inspection in which one or more tasks may or may not be requested based on the task inputs from other tasks. In such embodiments, the application software component may retrieve logical expressions from the data stored in the data store for an inspection which specifies which task to carry out based on how the logical expressions are evaluated for tasks that are carried out. For example, a task may include the logical expression that if the condition task input is 2 or below, then the application software component is to prompt the user to take an image of the part with the low condition. Whereas when the task input is 3 or above, then the application software does not prompt the user to take the image of the part.

In an example embodiment, the processor of the wearable device may be configured to detect that the wearable device has moved to a noisy environment and provide outputs different based on such a detection. For example, responsive to the detection that the wearable device has moved to a noisy environment, the processor may cause the wearable device to provide outputs through the at least one output device corresponding to one or more of the task requests that are relatively easier for the user to understand in a noisy environment compared to outputs provided through the at least one output device corresponding the same task requests, when a noisy environment has not be detected.

In this described example, the processor may be configured to monitor background noise via the microphone and adjust the manner in which task requests are outputted accordingly. For example, the processor may detect via the microphone that background noise levels are above a predetermined threshold (e.g., such as 115 db or other level) which typically degrades the ability of the user to accurately perceive audible versions of the task requests through speakers of the wearable device. Thus when noisy environments are detected, the processor may cause the display screen to display the text for the entire task request that currently is or would have been verbally spoken through the audio device. The audio of the task request may continue to be outputted or may be stopped when such noisy environments are detected. Whereas, when background noise levels are below such a predetermined threshold the verbal task request may continue to be provided through the audio device while the display device may display less than the entire text of the task request, such as a summary, name, or title of the particular task being verbally described through the audio device. In an example embodiment, the predetermined threshold for determining whether an embodiment is noisy may be a user configurable noise level value that is modified via a graphical user interface of the application software component.

In addition, when noisy environments are detected, the wearable device may modify the manner in which task inputs are received and for example may modify the task requests to explain how the modified task inputs are provided. For example, when a non-noisy environment is detected, the task requests may ask for task inputs that can be provided via verbal words and/or phrases through the microphone. However, when a noisy environment is detected, the task results may be modified to request that the user provide specific actions or movements that can be detected via one or more inputs devices other than the microphone.

For example, the task requests during a detected noisy environment may request that task inputs be provided via different button clicks, touch pad gestures, body motions or other non-verbal forms of communications via one or more of the input devices of the wearable device. For example, if the wearable device includes a button, the task request may request that the user click the button for the number of times that correspond to an input of a numeric condition. Also for a binary (yes/no) type response the task request may prompt the user to click a button one time for yes and two times for no. For a camera capture, the task request may request that a user touch the button once.

In another example embodiment, such non verbal inputs may include inputs provided via the motion sensor 124 (e.g., an accelerometer, gyroscope) or via a user facing camera 126. For example, to indicate an affirmative or yes response to a task request, the task request may prompt the user to pivot their head left and right one or more times, whereas to indicate an negative or no response to a task request, the task request may prompt the user to rotate their head up and down one or more times. In addition, to indicate a numeric value representative of a condition, the task request may prompt the user to rotate their head up and down for the number of times that correspond to the desired number.

Further, to cause the camera to take an image via an input from an accelerometer, the task request may prompt the user to stomp one of their feet. When a foot stomp is detected, the application may wait for several seconds for the camera to stop shaking and may then activate the camera on the wearable device to capture the desired image. For wearable devices with both an outward facing camera (for taking pictures of objects) and user facing camera (for taking images of a user wearing the wearable device), in a detected noisy environment, the task request may prompt the user to provide an affirmative type input motion to trigger a camera capture. For example the user may move their head up and down several times, which when detected by the user facing camera triggers the wearable device to take the image (such as of a portion of the inspected system) with the outwardly facing camera of the wearable device.

In example embodiments, when such task requests are outputted, the application software component may be configured to enter a mode that monitors inputs from buttons, touch pads, or motions sensors of the wearable device that corresponds to the particular clicks, touches, or motions requested to be performed in the task requests. It should also be appreciated that in some modes of operation, the application software component may be operative to accept inputs via either verbal commands, button clicks, touches, or body motions, whether or not a noisy environment is detected.

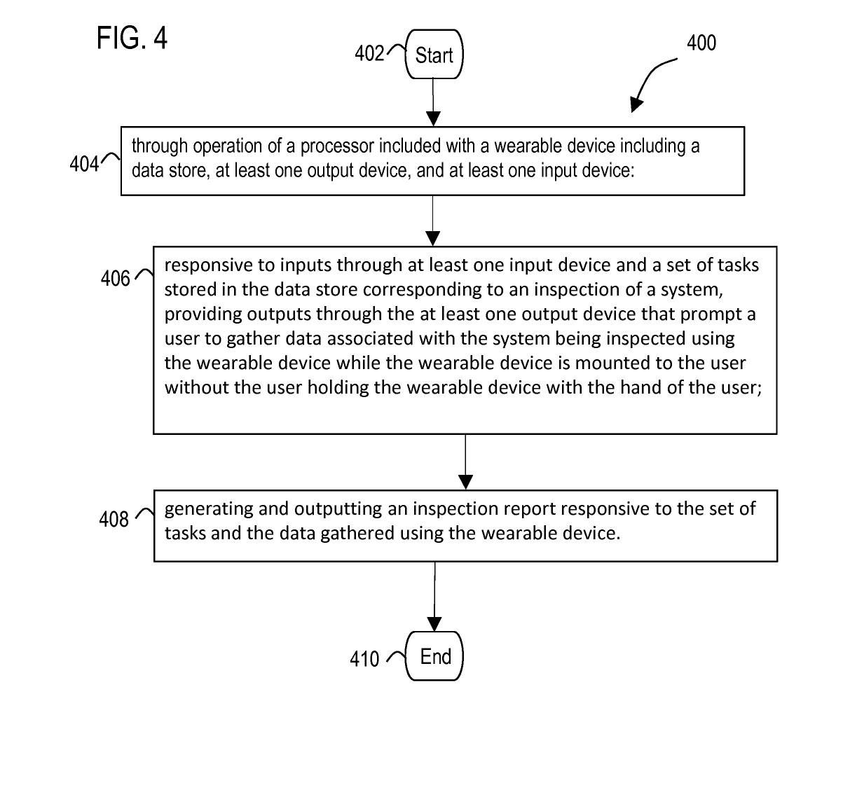

With reference now to FIG. 4, various example methodologies are illustrated and described. While the methodologies are described as being a series of acts that are performed in a sequence, it is to be understood that the methodologies may not be limited by the order of the sequence. For instance, some acts may occur in a different order than what is described herein. In addition, an act may occur concurrently with another act. Furthermore, in some instances, not all acts may be required to implement a methodology described herein.

It is important to note that while the disclosure includes a description in the context of a fully functional system and/or a series of acts, those skilled in the art will appreciate that at least portions of the mechanism of the present disclosure and/or described acts are capable of being distributed in the form of computer-executable instructions contained within non-transitory machine-usable, computer-usable, or computer-readable medium in any of a variety of forms, and that the present disclosure applies equally regardless of the particular type of instruction or signal bearing medium or storage medium utilized to actually carry out the distribution. Examples of non-transitory machine usable/readable or computer usable/readable mediums include: ROMs, EPROMs, magnetic tape, floppy disks, hard disk drives, SSDs, flash memory, CDs, DVDs, and Blu-ray disks. The computer-executable instructions may include a routine, a sub-routine, programs, applications, modules, libraries, a thread of execution, and/or the like. Still further, results of acts of the methodologies may be stored in a computer-readable medium, displayed on a display device, and/or the like.

Referring now to FIG. 4, a methodology 400 that facilitates data collection during an inspection is illustrated. The methodology may start at 402 and at 404 the methodology may include through operation of a processor included with a wearable device including a data store, at least one output device, and at least one input device, caring out acts 406 and 408. In this example act 406 may include responsive to inputs through the at least one input device and a set of tasks stored in the data store corresponding to an inspection of a system, providing outputs through the at least one output device that prompt a user to gather data associated with the system being inspected using the wearable device while the wearable device is mounted to the user without the user holding the wearable device with the hand of the user. Also in this example, act 408 may include generating and outputting an inspection report responsive to the set of tasks and the data gathered using the wearable device. At 410 the methodology may end.

In addition, the methodology 400 may include other acts and features discussed previously with respect to the system 100. For example, the act 406 may include causing the at least one output device to output a first task request to carry out a first task based at least in part on the set of tasks stored in the data store, which first task request prompts a user to provide a first task input using the at least one input device. The methodology may also include receiving sensor data from the at least one sensor and storing the sensor data in the data store in correlated relation with the first task, as well as receiving the first task input from the at least one input device and storing data corresponding to the first task input in the data store in correlated relation with the first task. Also in this example, act 406 may include responsive to the received first task input, causing the at least one output device to output a second task request to carry out a second task based at least in part on the set of tasks to be performed, which second task request prompts the user to provide a second task input corresponding to a measurement using at least one tool that is external to the wearable device. Further, the methodology may include the act of receiving the second task input including a measurement from the at least one tool and storing data corresponding to the second task input including the measurement in the data store in correlated relation with the second task.

As discussed previously, the at least one output device may include an audio device such as one or more speakers. Thus act 406 may include causing the first task request and the second task request to be verbally audibly outputted through the audio device. Also the first task request may prompt a user to provide the first task input via speaking verbal information through the microphone and the first task input may correspond to the verbal information provided through the microphone. Thus in this example, the act of storing data corresponding to the first task input may include storing the verbal information in the data store in correlated relation with the first task.

In addition as discussed previously, the wearable device may include a wireless interface device that is operable to communicate wirelessly with the tool. Thus the act of receiving the second task input may include receiving the second task input including the measurement from the tool through the wireless interface device. In addition the methodology may include responsive to the second task input causing the at least one output device to output a third task request to carry out a third task based at least in part on the set of tasks to be performed.

In example embodiments, the act 408 of outputting the inspection report may include wirelessly outputting the inspection report to an external computer system, which inspection report includes data corresponding to the first and second task inputs, including the verbal information and the measurement.

In a further example embodiment, the methodology may also include detecting that the wearable device has moved to a noisy environment. Then responsive to the detection that the wearable device has moved to a noisy environment, the methodology may include causing the wearable device to provide outputs through the at least one output device corresponding to at least one task request that requests an input through one of the input devices that is different than when a noisy environment is not detected.

Also as note previously a wearable device may include a camera and a microphone, and the described first task request may prompt a user to capture at least one image with the camera. Thus in this example, the methodology may include responsive to a verbal command received through the microphone, causing the camera to capture the at least one image, wherein the first task input includes the at least one image.

It should be appreciated that the described wearable device corresponds to a data processing system having a form factor suitable for wearing by a user. As discussed previously, the previously described acts associated with the above described methodologies may be carried out by one or more processors in the data processing system corresponding to the wearable device. Such processor(s) for example may execute software components operative to cause these acts to be carried out by the one or more processors. In an example embodiment, such software components may be written in software environments/languages/frameworks such as Java, JavaScript, Python, C, C#, C++ or any other software tool capable of producing components and graphical user interfaces configured to carry out the acts and features described herein.

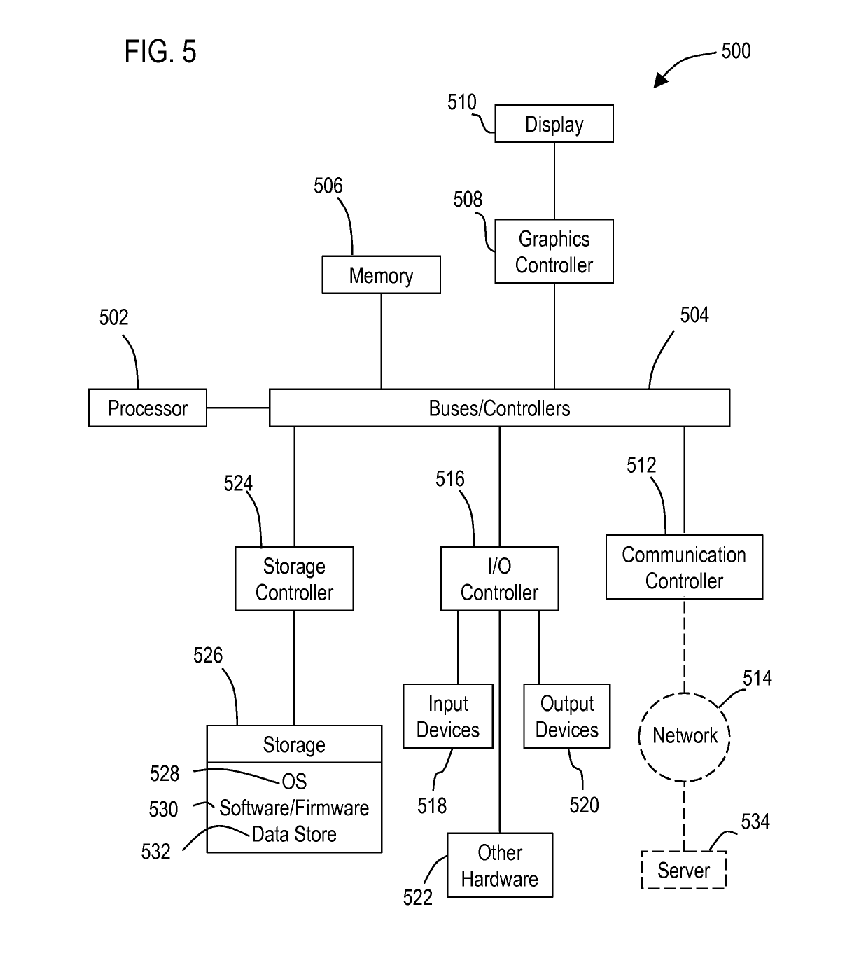

FIG. 5 illustrates a block diagram of a data processing system 500 (also referred to as a computer system) in which an embodiment can be implemented. The data processing system depicted includes at least one processor 502 (e.g., a CPU) that may be connected to one or more bridges/controllers/buses 504 (e.g., a north bridge, a south bridge). One of the buses 504 for example may include one or more I/O buses. Also connected to various buses in the depicted example may include a main memory 506 (RAM) and a graphics controller 508. The graphics controller 508 may be connected to one or more display devices 510. It should also be noted that in some embodiments one or more controllers (e.g., graphics, south bridge) may be integrated with the CPU (on the same chip or die). Examples of CPU architectures include IA-32, x86-64, and ARM processor architectures.

Other peripherals connected to one or more buses may include communication controllers 512 (Ethernet controllers, WiFi controllers, cellular controllers) operative to connect to a local area network (LAN), Wide Area Network (WAN), a cellular network, and/or other wired or wireless networks 514 or communication equipment.

Further components connected to various busses may include one or more I/O controllers 516 such as USB controllers, Bluetooth controllers, and/or dedicated audio controllers (connected to speakers and/or microphones). It should also be appreciated that various peripherals may be connected to the USB controller (via various USB ports) including input devices 518 (e.g., buttons, touch pad, motion sensing devices, cameras), output devices 520 (e.g., speakers, hepatic feedback vibration devices) or any other type of device that is operative to provide inputs or receive outputs from the data processing system. Further it should be appreciated that many devices referred to as input devices or output devices may both provide inputs and receive outputs of communications with the data processing system. Further it should be appreciated that other peripheral hardware 522 connected to the I/O controllers 516 may include any type of device, machine, or component that is configured to communicate with a data processing system.

Additional components connected to various busses may include one or more storage controllers 524). A storage controller may be connected to a storage device 526 such as one or more storage drives and/or any associated removable media, which can be any suitable non-transitory machine usable or machine readable storage medium. Examples include nonvolatile devices, volatile devices, read only devices, writable devices, ROMs, EPROMs, solid-state drives (SSDs), flash memory, and other known optical, electrical, or magnetic storage devices drives and/or computer media. Also in some examples, a storage device such as an SSD may be connected directly to an I/O bus 504 such as a PCI Express bus.

A data processing system in accordance with an embodiment of the present disclosure may include an operating system 528, software/firmware 530, and data stores 532 (that may be stored on a storage device 526). Such an operation system may employ a command line interface (CLI) shell and/or a graphical user interface (GUI) shell. The GUI shell permits multiple display windows or apps to be presented in the graphical user interface, with each display window or app providing an interface to a different application or to a different instance of the same application. An event input via touching a touch screen or touch pad, may be generated to actuate a desired response. Examples of operating systems that may be used in a data processing system may include Microsoft Windows, Linux, UNIX, iOS, and Android operating systems.

The communication controllers 512 may be connected to the network 514 (not a part of data processing system 500), which can be any public or private data processing system network or combination of networks, as known to those of skill in the art, including the Internet. Data processing system 500 can communicate over the network 514 with one or more other data processing systems such as a server 534 (also not part of the data processing system 500). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

Further, the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely.

In addition, it should be appreciated that data processing systems may be implemented as virtual machines in a virtual machine architecture or cloud environment. For example, the processor 502 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system may vary for particular implementations. For example the data processing system 500 in this example may correspond to a wearable device. However, it should be appreciated that alternative embodiments of a data processing system may be configured with corresponding or alternative components such as in the form of a mobile phone, tablet, controller board or any other system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, as used herein a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, which may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 500 may conform to any of the various current implementations and practices known in the art.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element which must be included in the claim scope: the scope of patented subject matter is defined only by the allowed claims. Moreover, none of these claims are intended to invoke 35 USC §112(f) unless the exact words “means for” are followed by a participle.

1. A system for data collection and reporting for inspections of equipment comprising:
a wearable device including a processor, a data store, at least one output device, and at least one input device,
wherein the processor in the wearable device is responsive to inputs through the at least one input device and a set of tasks stored in the data store corresponding to an inspection of a system to provide outputs through the at least one output device that prompt a user to gather data associated with the system being inspected using the wearable device while the wearable device is mounted to the user without the user holding the wearable device with the hand of the user,
wherein the processor in the wearable device is configured to generate and output an inspection report responsive to the set of tasks and the data gathered using the wearable device, and
wherein the processor in the wearable device is configured to detect that the wearable device has moved to a noisy environment and responsive to the detection that the wearable device has moved to a noisy environment, cause the wearable device to provide outputs through the at least one output device corresponding to at least one task request that requests an input through the at least one input device that is different than when a noisy environment is not detected.

2. The system according to claim 1, wherein the processor is configured to cause the at least one output device to output a first task request to carry out a first task based at least in part on the set of tasks stored in the data store, which first task request prompts a user to provide a first task input using the at least one input device, wherein the at least one processor is configured to receive the first task input from the at least one input device and to store data corresponding to the first task input in the data store in correlated relation with the first task, wherein the at least one processor is responsive to the received first task input to cause the at least one output device to output a second task request to carry out a second task based at least in part on the set of tasks to be performed, which second task request prompts the user to provide a second task input corresponding to a measurement using at least one tool that is external to the wearable device, wherein the at least one processor is configured to receive the second task input including a measurement from the at least one tool and to store data corresponding to the second task input including the measurement in the data store in correlated relation with the second task.

3. The system according to claim 2, wherein the at least one output device includes an audio device, wherein the processor is configured to cause the first task request and the second task request to be verbally audibly outputted through the audio device.

4. The system according to claim 3, wherein the first task request prompts a user to provide the first task input via speaking verbal information through a microphone, wherein the first task input corresponds to the verbal information provided through the microphone, wherein the processor is configured to store the verbal information in the data store in correlated relation with the first task.

5. The system according to claim 4, wherein the wearable device includes a wireless interface device that is operable to communicate wirelessly with the tool, wherein the processor is configured to receive the second task input including the measurement from the tool through the wireless interface device, wherein the processor is responsive to the received second task input to cause the at least one output device to output a third task request to carry out a third task based at least in part on the set of tasks to be performed.

6. The system according to claim 5, wherein the processor is configured to wirelessly output the inspection report to an external computer system, which inspection report includes data corresponding to the first and second task inputs, including the verbal information and the measurement.

7. The system according to claim 1, wherein the processor is configured to detect that the wearable device has moved to a noisy environment by detecting background noise with a microphone of the portable device that is above a predetermined noise threshold,
wherein when a non-noisy environment is detected by the processor, the at least one task request requests for at least one task input that is provided via verbal words through the microphone,
wherein when a noisy environment is detected by the processor, the at least one task request is modified to request that the user provide specific actions and/or movements that are detected via one or more input devices of the wearable device other than the microphone.

8. The system according to claim 7, wherein the wearable device includes eyewear that is configured to mount the processor, display device, microphone, and audio device to the head of the user in positions that enable the user can see and hear the first, second, and third task requests and provide the first task input via speaking into the microphone.

9. The system according to claim 8, further comprising the system and the tool, wherein the system includes a gas turbine, wherein the tool includes a caliper, wherein the measurement is of a portion of the gas turbine, wherein the wearable device includes a memory and an application software component, wherein the application software component is comprised of instructions that when included in the memory and executed by the processor, cause the processor to output the first, second, and third task requests, receive the first and second task inputs, store the first and second task inputs, and generate and output the inspection report.

10. The system according to claim 3, wherein the at least one input device of the wearable device further includes a camera and a microphone, wherein the first task request prompts a user to capture at least one image with the camera, wherein the at least one processor is responsive to a verbal command received through the microphone to cause the camera to capture the at least one image, wherein the first task input includes the at least one image.

11. A method for data collection and reporting for inspections of equipment comprising:
through operation of a processor included with a wearable device including a data store, at least one output device, and at least one input device:
responsive to inputs through the at least one input device and a set of tasks stored in the data store corresponding to an inspection of a system, providing outputs through the at least one output device that prompt a user to gather data associated with the system being inspected using the wearable device while the wearable device is mounted to the user without the user holding the wearable device with the hand of the user;
generating and outputting an inspection report responsive to the set of tasks and the data gathered using the wearable device;
detecting that the wearable device has moved to a noisy environment; and
responsive to detecting that the wearable device has moved to a noisy environment, causing the wearable device to provide outputs through the at least one output device corresponding to at least one task request that requests an input through the at least one input device that is different than when a noisy environment is not detected.

12. The method according to claim 11, wherein providing outputs includes:
causing the at least one output device to output a first task request to carry out a first task based at least in part on the set of tasks stored in the data store, which first task request prompts a user to provide a first task input using the at least one input device,
wherein further comprising:
through operation of a processor, receiving sensor data from the at least one sensor and storing the sensor data in the data store in correlated relation with the first task,
through operation of a processor, receiving the first task input from the at least one input device and storing data corresponding to the first task input in the data store in correlated relation with the first task,
wherein providing outputs further includes:
responsive to the received first task input, causing the at least one output device to output a second task request to carry out a second task based at least in part on the set of tasks to be performed, which second task request prompts the user to provide a second task input corresponding to a measurement using at least one tool that is external to the wearable device,
wherein further comprising:
through operation of the processor, receiving the second task input including a measurement from the at least one tool and storing data corresponding to the second task input including the measurement in the data store in correlated relation with the second task.

13. The method according to claim 12, wherein the at least one output device includes an audio device, wherein providing outputs includes causing the first task request and the second task request to be verbally audibly outputted through the audio device.

14. The method according to claim 13, wherein the first task request prompts a user to provide the first task input via speaking verbal information through a microphone, wherein the first task input corresponds to the verbal information provided through the microphone, wherein storing data corresponding to the first task input includes storing the verbal information in the data store in correlated relation with the first task.

15. The method according to claim 14, wherein the wearable device includes a wireless interface device that is operable to communicate wirelessly with the tool, wherein receiving the second task input includes receiving the second task input including the measurement from the tool through the wireless interface device, further comprising:
responsive to the second task input causing the at least one output device to output a third task request to carry out a third task based at least in part on the set of tasks to be performed.

16. The method according to claim 15, outputting the inspection report includes wirelessly outputting the inspection report to an external computer system, which inspection report includes data corresponding to the first and second task inputs, including the verbal information and the measurement.

17. The method according to claim 11, further comprising through operation of the processor:
detecting that the wearable device has moved to a noisy environment by detecting background noise with a microphone of the portable device that is above a predetermined noise threshold,
wherein when a non-noisy environment is detected by the processor, the at least one task request requests for at least one task input that is provided via verbal words through the microphone,
wherein when a noisy environment is detected by the processor, the at least one task request is modified to request that the user provide specific actions and/or movements that are detected via one or more input devices of the wearable device other than the microphone.

18. The method according to claim 17, wherein the wearable device includes eyewear, wherein the method is carried out by the processor in the wearable device while mounted to the head of the user in a position that enables the user to see and hear the first, second, and third task requests and provide the first task input via speaking into the microphone, wherein the system includes a gas turbine, wherein the tool includes a caliper, wherein the measurement is of a portion of the gas turbine, wherein the wearable device includes a memory and an application software component, wherein the application software component is comprised of instructions that when included in the memory and executed by the processor, cause the processor to output the first, second, and third task requests, receive the first and second task inputs, store the first and second task inputs, and generate and output the inspection report.

19. The method according to claim 13, wherein the at least one input device of the wearable device further includes a camera and a microphone, wherein the first task request prompts a user to capture at least one image with the camera, further comprising, through operation of the at least one processor responsive to a verbal command received through the microphone causing the camera to capture the at least one image, wherein the first task input includes the at least one image.

20. A non-transitory computer readable medium encoded with executable instructions that when executed, cause at least one processor included in a wearable device including a data store, at least one output device and at least one input device, to carry out a method for data collection and reporting for inspections of equipment comprising:
responsive to an input through the at least one input device and a set of tasks stored in the data store corresponding to an inspection of a system, providing outputs through the at least one output device that prompt a user to gather data associated with the system being inspected using the wearable device while the wearable device is mounted to the user without the user holding the wearable device with the hand of the user;
generating and outputting an inspection report responsive to the set of tasks and the data gathered using the wearable device;
detecting that the wearable device has moved to a noisy environment; and
responsive to detecting that the wearable device has moved to a noisy environment, causing the wearable device to provide outputs through the at least one output device corresponding to at least one task request that requests an input through the at least one input device that is different than when a noisy environment is not detected.
